(19) United States
(12) Patent Application Publication
(10) Pub. No.: US 2016/0357893 A1
(43) Pub. Date: Dec. 8, 2016

(54) Contact stiffness estimation based on structural frequency responses

(71) Applicant: Xianwu Ling, the Woodlands, TX (US)

(72) Inventor: Xianwu Ling, the Woodlands, TX (US)

(21) Appl. No.: 15/330,136

(22) Filed: Aug. 15, 2016

(51) Int. Cl. G06F 17/50; G06F 17/11

(52) U.S. Cl. CPC G06F 17/5018; G06F 17/11; G06F 2217/16

(57) ABSTRACT

Contact stiffness is a key in the FEA modeling of objectives involving contact. The present invention theoretically derives a new method for estimating the contact stiffness based on the base mode of structural frequency responses. The method provides both physical insight and practical guide in contact stiffness estimation, thus avoiding the ambiguity that confronts the contact stiffness estimation in commercial FEA developments and FEA applications. The method works particularly effectively in cases when the objectives under deformation include shell or beam elements. It can alleviate the convergence difficulties and improve the convergence speeds due to overestimated contact stiffness based on the underlying element.

### FIELD OF THE INVENTION

The present invention relates to a method for estimating the contact stiffness, and particularly in the Finite Element Analysis (FEA) developments and industrial applications.

### BACKGROUND OF THE INVENTION

The section explains the contact stiffness, reviews the current arts in selecting the contact stiffness and points out the weaknesses.

The finite element methods today have reached such a stage that they are well established in theories, well developed in commercial packages (such as Abaqus, Ansys, Ls-Dyna, Nastran, Adina, HyperWorks, AutoDesk, Comsol, and many other specialized FEA packages), and well accepted by every major industry from the aerospace and defense, the automobile, the high-tech, the consumer goods, the architecture and construction, to the energy and process and utilities.

Most of engineering problems involve more than one component. The mechanical interactions between components form the contact. Contact enforcement is the most challenging topic in the FEA developments. It is the source of many unconvergences that FEA practitioners experience in industrial applications of FEA. Numerically, contact is either enforced by the Lagrange multiplier or the penalty method. The Lagrange multiplier formulation does not require the contact stiffness, but it is more expensive and may lead to convergence difficulties such as chattering when overconstraint occurs among the interaction surfaces.

Our focus of this invention is on the penalty-based methods, which include the penalty method and the augmented Lagrange method (which augments the penalty contact force by yet another term, designed to mimic a Lagrange multiplier). In the penalty method, the normal contact stress σₙ as illustrated in FIG. 1 is given by

σₙ=kh, (1)

where k is the contact stiffness (in the unit of

$$[ \frac{N}{{m}^{3}} ] - FORCE / {LENGTH}^{3} ) ,$$

and h is the contact penetration depth. In the augmented Lagrange method,

σₙ=kh+λ, (2)

where λ is the extra term. The normal contact stiffness k is the most important parameter affecting both accuracy and convergence behavior. “All contact problems require a stiffness between the two contact surfaces. The amount of penetration between the two surfaces depends on this stiffness. Higher stiffness values decrease the amount of penetration but can lead to ill-conditioning of the global stiffness matrix, and to convergence difficulties. Ideally, you want a high enough stiffness that contact penetration is acceptably small, but a low enough stiffness that the problem will be well-behaved in terms of convergence or matrix ill-conditioning.” Currently, the choices of the contact stiffness, for instance by the different commercial FEA packages, are still of an art than a science.

The way most often employed by commercial FEA packages in determining the contact stiffness is given by

k=s kₑ (3)

where kₑ is the underlying element stiffness, and s is a scaling factor. Very few open literatures present a means/formula to estimate either the underlying element stiffness or the scaling factor, not to mention a physics-based method. Ls-Dyna adopts

$${k}_{e} = \frac{{KA}_{c}}{V}$$

for solid underlying elements and

$${k}_{e} = \frac{K}{max shell diagonal}$$

for shell underlying elements, where K is the material bulk modulus, A_{c} is the contact area, and V is the element volume. Ansys suggests to estimate the penalty stiffness as

$${k}_{e} = {f}_{bulk} E or {k}_{e} = \frac{{EA}_{c}}{V}$$

for bulky solids, where the factor ƒ_{bulk} is usually between 0.1 and 10. AutoDesk employs

$${k}_{e} = \frac{{EA}_{c}}{V} .$$

Abaqus calculates the underlying element stiffness based on the element modulus and the characteristic element length, but does not give the details.

For contacts in cases where the bending deformation, by either beam and/or shell elements, may dominate, there exists no such a rational method to select a penalty contact stiffness value that is just enough to push the contact in acceptable penetration and cause no ill-conditioning of the system, either. The other case in which the contact may often cause the convergence difficulty is two contacting bodies having dramatically different material modulus, for instance, one made of steel, and the other made of foam. In both cases, to the best knowledge of the inventor, the current best way is still by the ‘trial and error’ method as suggested by Abaqus, Ansys and Ls-Dyna, in which relaxed penalty stiffness is used to establish the appropriate contact status at the early stage and the penalty stiffness is increased incrementally until the result converges at a normal contact stiffness, so that the final accuracy is acceptable. One such an example is the user adaptive stiffness (*CONTACT CONTROLS, STIFFNESS SCALE FACTOR=USER ADAPTIVE) that the inventor implemented in Abaqus. Besides the extra computational costs by iteratively adjusting the contact stiffness to the final one, industrial FEA engineers are still faced with the puzzles such as: how much relaxed the early stiffness should be and how many iterations are appropriate and why the default element stiffness computed by commercial FEA packages such as Abaqus could be accepted as the NORMAL contact value? Unfortunately, no answers can be found on these questions.

For continuum element, the underlying element stiffness kₑ can be roughly estimated using a simplified model by analogy to the response of a rod under uniaxial compression as illustrated in FIG. 2a. Under uniaxial compression, the rod stress is given by

$$σ = \frac{E}{l} Δ l , \qquad ( 4 )$$

where E is the elastic Young's modulus of the bar, l is the length of the bar, and Δl is the displacement. Hence,

$${k}_{e} = \frac{E}{l} or \frac{EA}{V} ,$$

where A is the area of the bar cross section. The physical equivalence of contact stiffness is the axial stiffness of the rod. The contact penetration depth h plays the role of dl, as illustrated in FIG. 2b for a contact element. This analogy method forms the base of the method that uses the underlying element stiffness as the contact element stiffness most widely adopted by commercial FEA packages today.

For beam and shell underlying elements, no simplified models can be uniquely adopted. The major mode of deformations for beam and shell elements is bending. Hence, the bending stiffness should be used to represent their contact stiffness. However, as will become clear below, three difficulties are: first, the bending stiffness strongly depends on the element dimensions and profile; second, the bending stiffness depends on the loading type and boundary conditions; and third, the contact element behaves as a spring, and does not imbed a bending mode of deformation. The bending stiffness of beams and shells cannot be used directly as the contact stiffness, as they are not in the consistent units.

We demonstrate the above difficulties with a rectangle beam example. The beam is fixed at the left end and subjected to three types of loading as illustrated in FIG. 3. For the loading case FIG. 3a, the applied moment is related to the deflection as

$$M = \frac{1}{6} EW \frac{{t}^{3}}{{l}^{2}} δ . \qquad ( 5 )$$

For the loading case FIG. 3b, the applied force is related to the deflection as

$$F = \frac{1}{4} {Ew ( \frac{t}{l} )}^{3} δ . \qquad ( 6 )$$

For the loading case FIG. 3c, the pressure (in the unit of [N/m], not [N/m²]) is related to the deflection as

$$p = \frac{2}{3} Ew \frac{{t}^{3}}{{l}^{4}} δ . \qquad ( 7 )$$

The bending stiffness varies with the loading type. No physical guidance or literature reference can be found on how to convert the different bending stiffness to contact stiffness. In order to be consistent with the unit of kₑ, equations (5-7) are rewritten as

$$\begin{matrix}\frac{M}{wtl} = \frac{1}{6} ( \frac{E}{l} ) {( \frac{t}{l} )}^{2} δ , & ( 8 ) \\ \frac{F}{wt} = \frac{1}{4} ( \frac{E}{l} ) {( \frac{t}{l} )}^{2} δ , & ( 9 ) \\ \frac{pl}{wt} = \frac{2}{3} ( \frac{E}{l} ) {( \frac{t}{l} )}^{2} δ . & ( 10 )\end{matrix}$$

The left-hand side of equations (8-10) can be thought as representing some stress. The red terms on the right-hand side of equations (8-10) represent the element stiffness (in the unit of [N/m³]). The fraction constants before the red terms are not important, since it is the scaling contribution from the beam profile that we care the most.

With the above rearrangement, the stiffness of the beam is unified for the different loadings for the beams with a fixed end. They all scale the axial stiffness

$$( \frac{E}{l} )$$

by a factor of

$${( \frac{t}{l} )}^{2} .$$

Hence, it is advisable to adopt the contact stiffness of beams as

$${k}_{e} = \frac{E}{l} {( \frac{t}{l} )}^{2} . \qquad ( 11 )$$

This definition provides a partial solution to the three challenges above. The contact stiffness of shells can be pursued along the same line of thoughts. But this definition is not faultless, because 1) some stress on the left-hand side of equations (8-10) can only be vaguely defined in the sense of the consistency of units; 2) for a given beam height t, the stiffness strongly depends on the beam length, which in turn depends on the mesh discretization; and 3) still, the stiffness would depend on the boundary conditions.

In summary, defining the contact stiffness with the underlying element stiffness, however it is defined, is only a convenient way (as all element information are readily available). One inevitable consequence is the so-defined contact stiffness depends on the element length. This is not seen as an issue for bulky elements (except the case in which two materials differ dramatically in modulus), but when flexible structural elements are present and in contact, convergence issues often arise. The reason is because a flexible structure behaves much softer than the local contact elements do, due to the fact that the overall structural length is much longer than one individual element (remembering that the beam stiffness is inversely proportional to l³) . Physically speaking, for the flexible structure, the deformation is carried out through the cooperation of all the elements along the length, not particularly contributed by a single element/region. This invention provides the first ever rational global structure stiffness based method to overcome the difficulties of using the underlying element stiffness for estimating the contact stiffness.

### DESCRIPTION OF DRAWINGS

FIG. 1 is a schematic view of the normal contact stress σₙ versus the contact penetration h.

FIG. 2 is a schematic view of compression of a rod and its analogy to a contact element.

FIG. 3 is a schematic view of three types of bending of a beam with a fixed end.

FIG. 4 is a schematic view of the geometry and boundary conditions of the arch model.

FIG. 5 shows contour plots of the contact stress on the shell arch.

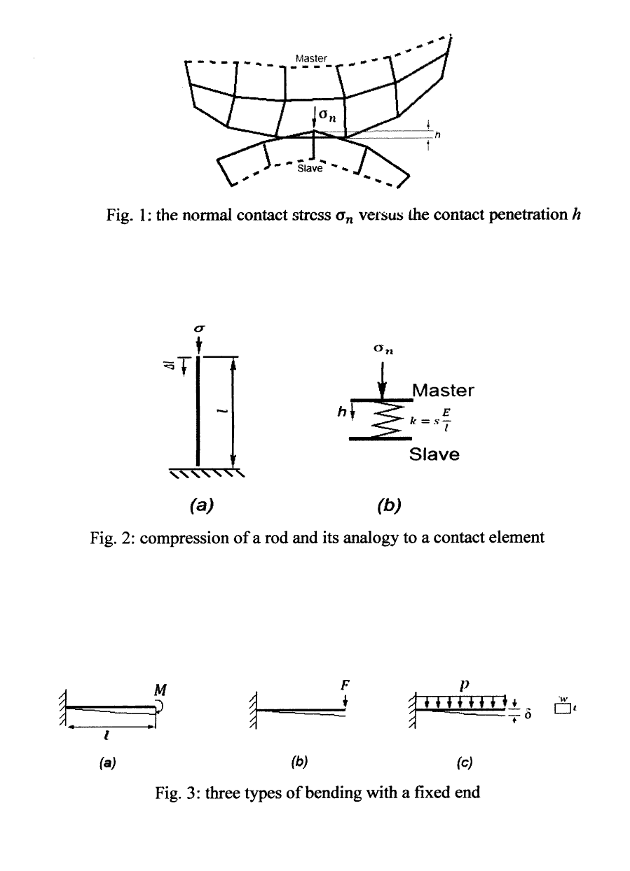

### DETAILED DESCRIPTION

In order to establish the relationship between the global structure stiffness and the contact stiffness of an individual contact element, there are two obstacles that have not been touched. First, what can best represent the global stiffness? Second, how can it be connected to the stiffness of the contact element?

It is known that the global stiffness matrix can best represent the global stiffness. It is sufficient enough, as it embodies in it every detail of the structure. But it is not specific enough to the useful point, as we need only some ‘reduced’ representative values of the matrix, so as to potentially bridge it to the contact stiffness. The first key point lies in the fact that the flexible structure deforms according to the dominance of the modes. The first fundamental mode, with the lowest eigenvalue of the system (except the modes of rigid motion), can best represent the structural global response. The best herein is understood in the sense of the largest participation factor of the first base mode. The first base mode is usually associated with bending deformation (if present), and requires the least applied energy. The base modal stiffness associated with the first fundamental mode is the stiffness that the structure will mostly reveal itself when subjected to an external loading. Hence, it is the fundamental modal stiffness that is interest here.

To extract the fundamental modal stiffness, the first step is extracting the first few natural frequencies on the disjoint components of the regular elements only. The ‘disjoint’ herein means that no contact will be included in the extracting process, since it is assumed we do not know the contact stiffness yet. Nearly all major commercial FEA packages can extract the natural frequencies of a structure, and often, very efficiently. The second step is selecting the lowest eigenvalue λ^{b} or natural frequency ω^{b} with its associated lumped mass m^{b} from the results. Most often, the rigid modes can be easily detected and excluded from the selection, as their eigenvalues are very close to the zeroes. From the frequency analysis, one has

k^{b}=m^{b}λ^{b}=m^{b}(2π ^{b})². (12)

where k^{b} is the base modal stiffness of the structure. Note that the unit of the stiffness k^{b} is [N/m], not [N/m³] as that of the contact stiffness kₑ.

One clarification needs to be made on the base modal mass m^{b}. Most FEA packages normalize the eigenvectors either by the displacement or by the mass. In the former case, the largest displacement entry in each vector is made unity; while in the latter case, the generalized mass for each mode is made unity. In either case, the generalized mass reported is not the actual modal mass. When the normalization is by the mass, the effective modal masses (in any translational direction) sums to the total mass of the model, with one mass dominating in the base modal effective mass vector, and the rest being tiny negligibly small. This dominating mass is chosen as the base modal mass m^{b}. It is noticed that the boundary conditions affect the base mode, and accordingly the base eigenvalue and effective mass. The boundary conditions in the natural frequency extraction are best selected to mimic that of the physical model. It is strongly advisable to visually verify that the mode shape if uncertainty in the selection prevails. Also, it is strongly advisable to remove the rigid motions if physically permitted, especially the translational rigid motion for structural elements. It is noticed that the effective masses for the rigid motions if not removed will overwhelm the one for the base mode of interest.

For a cantilever beam, the first natural frequency of the beam can be derived analytically as

$${ω}^{b} = \frac{{1.875}^{2}}{2 π} \sqrt{\frac{EI}{ρ {Al}^{4}}} , \qquad ( 13 )$$

and its effective mass is

m^{b}=0.6131ρAl, (14)

where A is the beam cross section area. The fundamental modal stiffness of a cantilever beam is

$${k}^{b} = {( 2 {πω}^{b} )}^{2} m = 7.58 \frac{E}{l} \frac{I}{{l}^{2}} , \qquad ( 15 )$$

which provides a generic form that accounts for the beam profile and length. For a rectangle beam, it simplifies to

$${k}^{b} = 0.63 wt \frac{E}{l} {( \frac{t}{l} )}^{2} . \qquad ( 16 )$$

This definition can be extended to a rectangle shell, when t <<w.

The static stiffness of a structure differs conceptually from the model stiffness and those two are calculated using different methods. But as Wahyuni et al. showed that the static stiffness and the modal stiffness are correlated, and that the fundamental modal stiffness dominates the contributions to the static stiffness. Putting all these together, this invention employs the fundamental modal stiffness as the global structure stiffness.

The question now becomes: how can the global structure stiffness be related to the contact stiffness? To be more precise mathematically, we look at the stiffness matrix of a contact element ‘e’ formulated by the penalty method, which takes the form as

$${[ k ]}^{e} = {k}_{e} {A}_{c} \{ {[ g ]}_{lin}^{e} + {\frac{h}{l} [ g ]}_{nlgoem}^{e} + {O ( \frac{h}{l} )}^{2} \} \qquad ( 17 )$$

where A_{c} is the area of the contact element, h is the contact penetration, l is a characteristic length of the underlying element, and [g]ₗᵢₙ^{e} and [g]_{nigoem}^{e} are non-dimensional geometrically linear and nonlinear matrices contributed only by the orientation and position of the contact surfaces. All terms of [g]ₗᵢₙ^{e} and [g]_{nigoem}^{e} have well bounded values in the order of the unity. Equation (17) shows the element contact area A_{c} raises the contact element stiffness kₑ in the unit of [N/M³] to that of the structural stiffness [N/M].

The key to the bridging is enforcing the fundamental mode onto the systems including the contacts. As emphasized above, the fundamental mode is the mode that the structure is likely to take in the predominant sense, so its stiffness would best represent the one that is likely to occur, even in the presence of the contact. Hence, it is physically reasonable to write

kₑA_{c}=s k^{b}, (18)

which yields,

$${k}_{e} = s \frac{{k}^{b}}{{A}_{c}} . \qquad ( 19 )$$

The unitless scaling factor ‘s’ is to give the user more flexibility so that the contact force induced by the penalty method can be controlled within a given tolerance to that as calculated by the Lagrange multiplier method. One example is given in the Appendix to illustrate how the scaling factor ‘s’ is related to the relative error of the contact force between the two methods. Note that the enforcement of the base mode onto the systems is only virtual in nature, so as to balance the contact responses.

The most advantage features of the contact stiffness thus defined are that the contact stiffness is proportional to the base stiffness of the structure k^{b}. Hence, it has the global contribution made by the structure as a whole. This is very important an improvement over any forms of contact stiffness defined locally using the underlying element, especially in cases when the global response can be much softer than that of an individual element, due to the length scale involved, for beams and shells. This improvement is also expected to work effectively for the contact difficulty when two materials differ dramatically in modulus. The fundamental modal stiffness k^{b} changes as the structure deforms. But as I noticed through many example problems, use of the initial k^{b} has already improved the convergence behavior dramatically. It is possible to extract the fundamental modes with time, which is a costly procedure and not taken by the inventor yet. If the variation of fundamental modal stiffness k^{b} with time is made available, either through some automatic script or built-in routines, it is an easy extension to make the contact stiffness time-dependent.

To demonstrate the advantage, a comparison is made of the two definitions of contact stiffness for a rectangle beam—the local-based contact stiffness (denoted as k^{L} now) by equation (1) where the underlying element stiffness is defined by equation (11) and the global-based contact stiffness (denoted as k^{G}) by equations (16) and (19) from the mode analysis. Special attention has to be paid now on the physical meanings of the lengths attached to each definition. In equation (11), the length l is a characteristic length of the underlying element, which is denoted as l^{e} here, while in equations (16) and (19), the length l is the total beam length L. Hence, one has

$$\frac{{k}^{L}}{{k}^{G}} = \frac{\frac{E}{l} {( \frac{t}{l} )}^{2}}{s \frac{{k}^{b}}{{A}_{c}}} = \frac{{A}_{c} \frac{E}{{l}^{e}} {( \frac{t}{{l}^{e}} )}^{2}}{s 0.63 w t \frac{E}{L} {( \frac{t}{L} )}^{2}} . \qquad ( 20 )$$

For beams and trusses, Abaqus defines le as the length along the element axis. Assume that the beam is divided into n elements along the axis, i.e., L=nl^{e}. Meanwhile, the contact is assumed to occur on the element top surface, i.e., A_{c}≃wl^{e}. Then,

$$\frac{{k}^{L}}{{k}^{G}} = \frac{1.59}{s} {n}^{2} \frac{L}{t} , \qquad ( 21 )$$

from which, it becomes clear that, for a scaling factor of 10 (see the Appendix), the contact stiffness locally defined based on the underlying element can easily overestimate that of the global response by several orders. What is missing in the definition of the contact stiffness based on the underlying element is the slenderness of the beam

$$( \frac{L}{t} )$$

and the element discretization (n²).

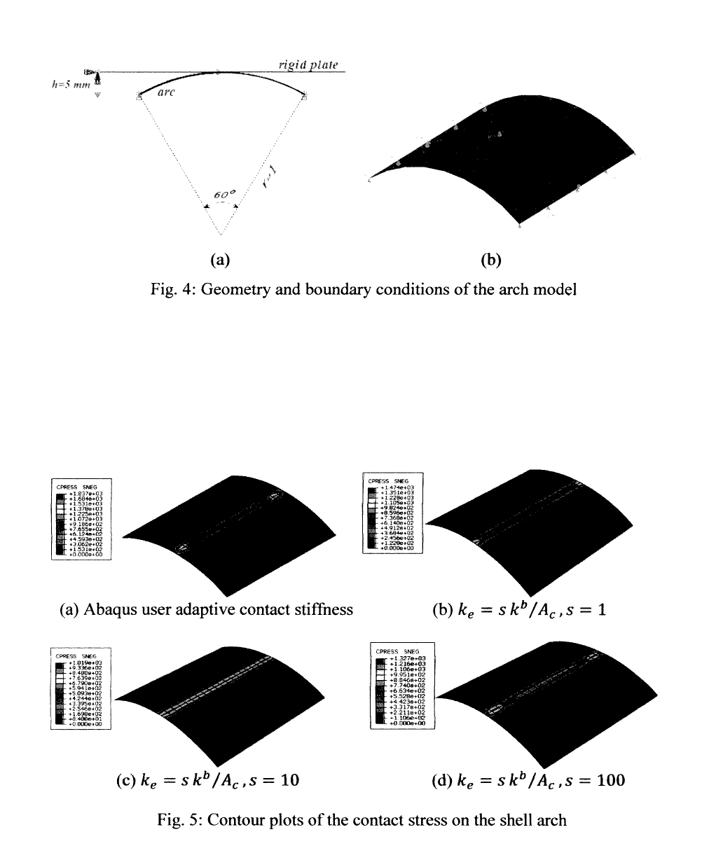

Besides the beam contact example problem in the Appendix, several other numerical examples are tested in this invention to show the effectiveness of the contact stiffness based on the fundamental global response. The first example presented here is a shell arch with a radius of 1 m, a thickness of 2 mm, a central angle of 60°, and a width of 1.05 m, as shown in FIG. 4(a). Steel is the assumed material with ρ=7800 kg/m³, E=2×10¹¹N/m², and ν=0.32, where ν is the Poisson's ratio. The arch is divided into 20 SR4 elements along both the arc and the width directions. To illustrate the importance of contact stiffness, the initial and the minimum time steps are both set to 1, so as to test the convergence of the arch in a single increment. The boundary conditions are shown in FIG. 4(b), so set as to remove the rigid modes for the frequency analysis. A rigid plate is placed just in contact with the arch from the top initially, and driven down by 5 mm in the loading step. The loading fails to converge with Abaqus default hard contact.

Abaqus provides a technology (*CONTACT CONTROLS, STIFFNESS SCALE FACTOR=USER ADAPTIVE) that is intended to improve convergence behavior without sacrificing accuracy by using reduced penalty stiffness in the early iterations of the first increment and returning to the default penalty stiffness for the final iterations of the first increment and all subsequent increments. Reduced early penalty stiffness is to find a contact status approximate to the final converged one, while increased subsequent stiffness is to correct the solution accuracy. The price paid is higher computational cost since all intermediate ‘converged’ results are discarded until the last one, since their penalty stiffness used are lower than the default one. This cost is affordable, since this technology is only valid for the first increment, when non-convergence arises due to the contact status changes over a large portion of the contact area initially. For the arch problem, using Abaqus default scale factors for the user adaptive stiffness, the job converges in a total of 21 iterations. The contour plot of the contact pressure is shown in FIG. 5(a).

The base eigenvalue and its effective mass of the shell component are extracted using the boundary conditions as shown in FIG. 5(b). Their values are 860.7 and 13.2, respectively. Hence, the base modal stiffness k^{b}=860.7×13.2=11361. Abaqus UINTER is employed to implement the user defined interfacial constitutive kₑ=sk^{b}/Λ_{c}, where the element contact area A_{c} is supplied by Abaqus into UINTER. The scaling factor ‘s’ is left as a user input, set to 1, 10, 100, and 1000 for comparison purpose. FIG. 5(b)-(d) show the contour plots of the contact stress for the jobs when s=1, 10, and 100, respectively. The job in which s=1000 does not converge, indicating that too large a contact stiffness, even with the current formula (19), can lead to non-convergence. The total iterations taken to complete the jobs in which s=1,10, and 100 are 8, 9, and 10, respectively. Comparing the contact stress contour plots in FIG. 5, it can be noticed that (1) the maximum contact stress can easily differ tens of percentage just by varying the scaling factor; (2) Abaqus default contact stiffness appears to overestimated, as it predicted the largest contact stress (1,837 Pa) ; (3) as that in the Appendix example problem, the best scaling factor for the arch problem appears to be ˜10, as it produces the most uniform distribution of the contact stress along the top contact line; and (4) the mode based contact stiffness, besides being a generic physics-based formula, improves not only the solution accuracy, but also the solution efficiency.

The scaling factor ‘s’ plays the role as an adjuster between the accuracy and the efficiency. In this Appendix, we provide some general guidance on selecting the scaling factor with the example problem of a cantilever beam.

The cantilever beam of length l=0.45 m is subjected to a uniform pressure load

$$p = 100 \frac{kN}{m} .$$

Its width and height are 0.02 m and 0.003 m, respectively. Its Young's modulus 2×10¹¹N/m², and its density 92 =7800 kg/m³. A rigid block is placed beneath the free end. The initial gap δ=0.001 m. The contact force can be analytically derived from the no-penetration constraint

$$h ( x = l ) = \frac{{px}^{2}}{24 EI} ( {x}^{2} + 6 {l}^{2} - 4 lx ) - \frac{λ {x}^{2}}{6 EI} ( 3 l - x ) - δ = 0 , \qquad ( 22 )$$

which gives π=16.58 N.

A simple Abaqus natural frequency job is set up for the cantilever beam, which gives the base eigenvalue as 5794.8, and its associated mass as 0.129. The exact solutions from formula (13-14) give the base eigenvalue 5796.3, and the associated mass 0.129. Abaqus solutions match very well the exact solutions. The base stiffness of the beam is 5796.3×0.129=747.7. For the cantilever beam with contact, a simple Abaqus model is setup using 20 SR4 shell elements along the beam axis. The initial time step is set to 0.1 and the maximum time step is 0.25. The rigid block is modeled using an analytical rigid plate. Abaqus converges in a total of 12 iterations with the default penalty hard contact. The predicted contact force is 17.43 N, with a relative error of 5.13%. Abaqus UINTER is employed to implement the user defined interfacial constitutive. The relative error is defined as

$$e = \frac{{F}^{p} - λ}{λ} , \qquad ( 23 )$$

where F^{p} is the contact force reported at the reference point of the rigid plate. Table 1 lists the calculated contact forces, their relative errors, and the total iterations.

TABLE 1
Calculated contact forces versus the scaling factor.

| s | 1 | 10 | 100 | 1000 |
|---|---|---|---|---|
| F^{p} (N) | 14.14 | 16.65 | 16.95 | 16.98 |
| e | −14.7% | −0.42% | +2.23% | +2.41% |
| Iterations | 11 | 7 | 10 | 13 |

It is worth noting that the best scaling factor, for the cantilever beam problem under study, is about 10. The relative error is very small. An optimal scaling factor seems to exist. The scaling factor, if chosen appropriate, not only significantly decreases the relative error, but also improves the convergence speed. Too large a scaling factor harms both the accuracy and the efficiency.

Abaqus beam elements were tested, but found to report the incorrect the contact area. For instance, the above beam was tested using 20 B31 elements. UINTER prints the contact area as 1.125E-2. When the same beam was modeled using the 20 SR4 elements, the contact area is correctly reported as 3.75E-5. Abaqus reported beam contact area was overwhelmingly high.

OTHER PUBLICATIONS

Abaqus Users Manual, http://abaqus.software.polimi.it/v6.14/index.html. http://moodle.insa-toulouse.fr/pluginfile.php/42654/mod resource/content/3/CONTACT_Imulia.pdf http://www.dynasupport.com/tutorial/ls-dyna-users-guide/contact-modeling-in-ls-dyna http://ansys.net/ansys/papers/nonlinear/contact_tcch.pdf. http://www.algor.com/news_pub/tech_white_papers/surface_contact/Zavarise et al. “A non-consistent start-up procedure for contact problems with large load-steps”, Comput. Methods Appl. Mech. Engrg. 205-208(2012) 91-109.

Wahyuni et al. “Relationship between static stiffness and modal stiffness of structures”, The Journal for Technology and Science, 21(2010),1-3.

http://iitg.vlab.co.in/?sub=62&brch=175&sim=1080&cnt=1 http://www.vibrationdata.com/tutorials2/ModalMass.pdf

What is claimed is:

1. A physics-based method, comprising:
a natural frequency analysis, from which the base mode of the disjoint components of a mechanical system (or a structure) is determined, and from which the base eigenvalue (or frequency) and its associated effective modal mass are analyzed;
the base structural stiffness is calculated by multiplying the base eigenvalue (or frequency) with its associated effective modal mass;
the contact stiffness of each individual contact element is set equal to the base structural stiffness over the element contact area, multiplied by a scale factor.

2. The method of claim 1, where the components are disjoined in the sense that no mechanical contact between the components be considered in the frequency analysis.

3. The method of claim 2, where the rigid motions of the system (especially the translational rigid motion) be eliminated for the disjoint components so that the effective modal masses reported are correct.

4. The method of claim 3, where the eigenvectors are normalized by the mass so that the effective masses reported corresponds to the physical ones.

5. The method of claim 1, where the analytical formula of the base structural stiffness of a beam is explicitly given.

6. The method of claim 5, where the analytical formula of the base structural stiffness of a beam be extended to a shell.

7. The method of claim 1, where the dimensionless scale factor be adjustable to optimize the computational efficiency and solution accuracy;

8. The method of claim 8, an optimal scale factor exists in the order of tens for shell elements.

9. The method of claim 1, where the contact stiffness of each individual contact elements can be made a combination of the structural stiffnesses of the base, the first, the second, etc. of the frequency modes.

10. The method of claim 1, where the method is either used initially at the beginning of a job analysis, or used iteratively during the course of a job analysis.

11. The method of claim 1, where the method is implemented or employed either manually, semi-automatically with a script, or automatically with built-in routines.
